(19) United States
(12) Patent Application Publication
(10) Pub. No.: US 2010/0272423 A1
(43) Pub. Date: Oct. 28, 2010

(54) SHAKE CORRECTING APPARATUS AND IMAGING APPARATUS HAVING THE SAME

(75) Inventor: MASAMICHI OHARA, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/764,310

(22) Filed: Apr. 21, 2010

(30) Foreign Application Priority Data
Apr. 23, 2009 (JP) 2009-104962

(51) Int. Cl. G03B 17/00; G02B 27/64

(52) U.S. Cl. 396/55; 359/557

(57) ABSTRACT

A shake correcting apparatus includes a correcting unit operable to correct an optical axis of light from a subject according to a correction signal, a shake detecting unit operable to detect shake of a target to output a detection signal according to an amount of the detected shake, a correction signal generating unit operable to generate the correction signal based on the detection signal output from the shake detecting unit, a natural oscillation detecting unit operable to detect a frequency component of the detection signal in a predetermined frequency band, and a controller operable to control the correction signal generating unit to generate the correction signal according to a detection result of the natural oscillation detecting unit.

### BACKGROUND

1. Technical Field

The present invention relates to an apparatus for correcting shake of an optical axis, and to an imaging apparatus having the same.

2. Related Art

Conventionally, a lot of cameras provided with a detecting unit, such as a gyro sensor (angular rate sensor), for detecting shake of a camera body are present. The detecting unit detects oscillation in a frequency band of about 1 to 10 Hz caused by camera shake of a photographer, and a camera performs various controls relating to the correction of the camera shake based on the detection result. Concretely, lens drive is controlled to reduce influence of the camera shake on an captured image.

In general, the detecting unit such as a gyro sensor has a frequency band including a frequency (hereinafter, “natural frequency”) at which detection sensitivity becomes very high, in a frequency band higher than a camera shake frequency (about 1 to 10 Hz). For example as shown in FIG. 12, there is a band of the natural frequency at which the detection sensitivity becomes very high in a frequency band of 500 to 1000 Hz. A frequency of a mechanical noise caused by a shutter operation or a motor drive of a camera occasionally may match with the natural frequency. For this reason, when the detecting unit detects the frequency that matches with the natural frequency, a control unit of the camera may perform an erroneous operation for camera shake correction.

In order to solve such a problem, for example Japanese Patent No. 3782705 discloses a technique that measures oscillation out of a detection range of the gyro sensor just after a start switch of the camera is turned on, and obtains a driving condition of a drive unit for driving respective functional sections of the camera with less influence on the detection operation of the gyro sensor.

However, according to a method for driving the drive unit under the drive condition with less influence on the detection operation of the gyro sensor, the drive condition of the respective functional sections of the camera is greatly restricted. Further, when an operation for obtaining the drive condition is performed every time the camera is turned on, a user cannot perform an operation of the camera for taking a photo just after the power is on.

### SUMMARY

In order to solve the above problem, it is an object to provide a shake correcting apparatus that can prevent an erroneous lens correction operation caused by a mechanical noise and the like without restricting drive conditions of respective functions of a correction target, and provide an imaging apparatus having the same.

In a first aspect, a shake correcting apparatus for correcting shake of an optical axis is provided. The shake correcting apparatus includes a correcting unit operable to correct the optical axis of light from a subject according to a correction signal, a shake detecting unit operable to detect the shake of the apparatus to output a detection signal according to an amount of the detected shake, a correction signal generating unit operable to generate the correction signal based on the detection signal output from the shake detecting unit, a natural oscillation detecting unit operable to detect a frequency component of the detection signal in a predetermined frequency band, and a controller operable to control the correction signal generating unit to generate the correction signal according to a detection result of the natural oscillation detecting unit.

In a second aspect of the present invention, an imaging apparatus having an optical system and an imaging unit operable to capture a subject image input via the optical system is provided. The imaging apparatus includes a correcting unit operable to correct an optical axis of light from a subject according to a correction signal, a shake detecting unit operable to detect shake of the imaging apparatus and output a detection signal according to an amount of the detected shake, a correction signal generating unit operable to generate the correction signal based on the detection signal output from the shake detecting unit, an natural oscillation detecting unit operable to detect a frequency component of the detection signal in a predetermined frequency band, and a controller operable to control the correction signal generating unit to generate the correction signal according to the detection result of the natural oscillation detecting unit.

According to the aforementioned aspects, presence/non-presence of a signal component of a predetermined frequency is detected in a detection signal indicating a shake amount, and control for generating a correction signal is varied based on the detection result. Thus, even when oscillation of a natural frequency of the detecting unit is detected, the correction signal can be controlled so that the correction operation is not performed. Therefore, even when a mechanical noise and the like having a frequency close to the natural frequency are generated, an erroneous correction operation caused thereby can be prevented without restricting the drive conditions for driving respective functions of the camera.

### BRIEF DESCRIPTION OF DRAWINGS

FIG. 1 is a block diagram illustrating a configuration of a digital camera according to an embodiment.

FIG. 2 is a block diagram illustrating a configuration of a shake detecting apparatus according to a first embodiment.

FIGS. 3A to 3D are diagrams describing signals to be processed by the shake detecting apparatus according to the first embodiment.

FIG. 4 is a flowchart illustrating an operation of the shake detecting apparatus according to the first embodiment.

FIG. 5 is a block diagram illustrating a configuration of the shake detecting apparatus according to a second embodiment.

FIGS. 6A to 6D are diagrams describing signals to be processed by the shake detecting apparatus according to the second embodiment.

FIG. 7 is a flowchart illustrating an operation of the shake detecting apparatus according to the second embodiment.

FIG. 8 is a flowchart illustrating an operation of the shake detecting apparatus according to a third embodiment.

FIG. 9 is a flowchart illustrating an operation of the shake detecting apparatus according to a fourth embodiment.

FIG. 10 is a block diagram illustrating another configuration of the shake detecting apparatus for outputting a control signal representing an angle of shake.

FIG. 11 is a block diagram illustrating another configuration of the shake detecting apparatus for outputting a control signal representing an angle of shake.

FIG. 12 is a diagram describing a natural frequency of a gyro sensor.

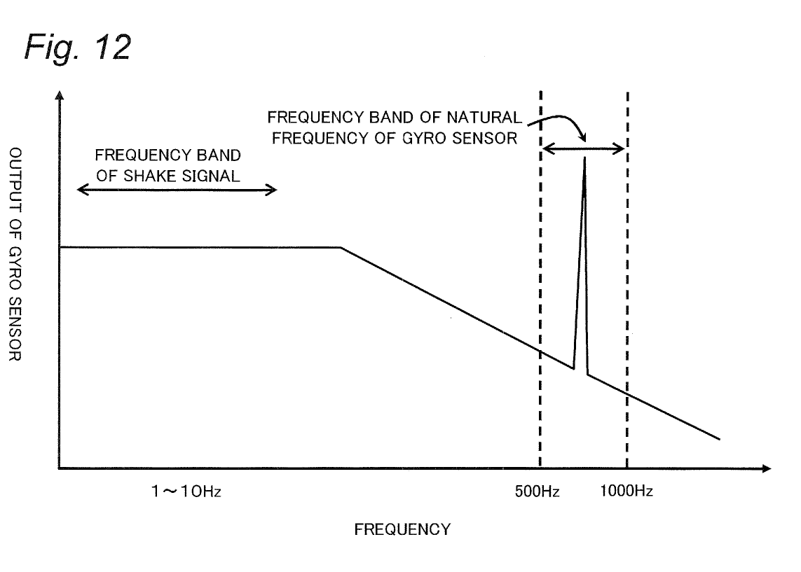

### DETAILED DESCRIPTION OF PREFERRED EMBODIMENTS

Preferred embodiments are described below with reference to the drawings. In the following description, a detecting apparatus is mounted to a digital camera.

### First Embodiment

According to a first embodiment, a digital camera provided with a detecting apparatus does not perform calculation of a correction amount for driving a camera shake correction lens, when the detecting apparatus detects shake of the same frequency as a natural frequency of a gyro sensor (angular rate sensor). A configuration and an operation of a digital camera 1 provided with a detecting apparatus 2a according to the first embodiment are described in detail below.

### 1-1. Configuration of Digital Camera

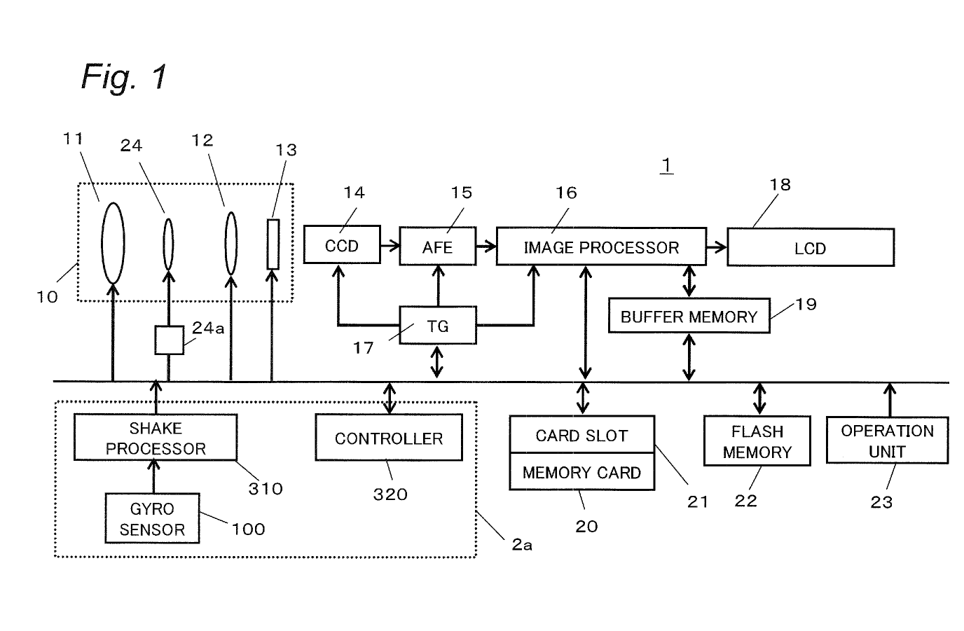

FIG. 1 illustrates a block diagram of an electrical configuration of the digital camera 1.

The digital camera 1 captures a subject image incident through an optical system 10 with a CCD image sensor 14. Image data generated by the capturing is subjected to a predetermined process in an AFE (analog front end) 15 and an image processor 16. The image data is recorded in a flash memory 22 or a memory card 20. The image data recorded in the flash memory 22 or the memory card 20 is output on a liquid crystal display (LCD) 18 by an operation of a user on an operation section 23. The digital camera 1 detects shake of the digital camera 1 with a gyro sensor 100 and controls drive of a camera shake correction lens 24 to reduce influence of the shake on the captured image. The configuration of the digital camera 1 is described below.

A focus lens 11 is used for adjusting a focal length. A zoom lens 12 is used for adjusting enlargement/reduction factor. A diaphragm 13 is used for adjusting an amount of light incident on the CCD image sensor 14. The focus lens 11, the zoom lens 12 and the diaphragm 13 are controlled by a controller 320 via the respective drive apparatuses.

The camera shake correction lens 24 is driven by a correction lens drive device 24a under control of the controller 320. Specifically, the correction lens drive device 24a moves the camera shake correction lens 24 on a plane perpendicular to an optical axis according to a shake signal detected by the gyro sensor 100. Thus, the optical axis of the optical system 10 is corrected according to the shake signal.

The lenses of the optical system 10 may be composed of any number of lenses, or any number of lens groups.

The CCD image sensor 14 converts light collected through the optical system 10 into an electric signal. A lot of photodiodes are arranged two-dimensionally on a light receiving surface of the CCD image sensor 14. The light from the subject passes through the optical system 10, and then is imaged on the light receiving surface of the CCD image sensor 14. The light from the subject is accumulated as electric charges on the light receiving surface by a photoelectric effect. The electric charges accumulated on each light receiving surface are transferred to an amplifier with vertical CCDs and horizontal CCDs, so that an image signal is generated. In the present embodiment, another imaging element such as a CMOS image sensor or an NMOS image sensor may be used instead of the CCD image sensor 14.

The AFE (analog front end) 15 applies, to an image signal generated by the CCD image sensor 14, correlated double sampling, gain adjustment, and conversion of image data from an analog format to digital format. Thereafter, the AFE 15 outputs the image data including RGB signals to the image processor 16.

The image processor 16 executes various processes on the image data. The various processes include at least one of gamma correction, white balance correction, YC conversion process, electronic zoom process, compression process, decompression process, and the like. Further, the various processes may include another process. The image processor 16 may be composed of a hard-wired electronic circuit, or a microcomputer using a program. The image processor 16 may be composed of one semiconductor chip as well as the controller 320 or the like.

The liquid crystal display 18 displays an image based on image data for display processed by the image processor 16. The liquid crystal display 18 can also display information about setting conditions of the digital camera 1 in addition to images. The display is not limited to a liquid crystal system, a plasma system, and an organic EL system, and thus various display apparatuses can be used as long as they display images.

An entire operation of the digital camera 1 according to the first embodiment is integrally controlled by the controller 320. The controller 320 may be composed of a hard-wired electronic circuit, or a microcomputer using a program. Further, the controller 320 may be composed of one semiconductor chip as well as the image processor 16 or the like. Further, the controller 320 may have an internal memory.

The controller 320 generates a vertical synchronizing signal periodically, and outputs the vertical synchronizing signal to a TG (timing generator) 17. The TG 17 generates synchronizing signals for driving the CCD image sensor 14, the APE 15, the image processor 16, a shutter (not shown), various motors or the like (not shown) based on the vertical synchronizing signal.

A buffer memory 19 is a storage unit serving as a work memory of the image processor 16 and the controller 320. The buffer memory 19 can be realized by DRAM (Dynamic Random Access Memory).

The flash memory 22 functions as an internal memory for storing image data and the like. The controller 320 stores image data processed by the image processor 16 in the flash memory 22 or the memory card 20.

A card slot 21 receives the memory card 20. The card slot 21 can electrically and mechanically connect to the memory card 20. The card slot 21 may have a function for controlling the memory card 20.

The memory card 20 is an external memory containing a storage section such as a flash memory therein. The memory card 20 can store data such as image data to be processed by the image processor 16. In the present embodiment, the memory card 20 is described as one example of the external memory, but the external memory is not limited to this. For example, a storage medium such as an optical disc may be used as the external memory.

The operation section 23 includes an operating member that receives operations of a user. The operating member includes a button, a slide type switch, and a touch panel provided to an exterior of the digital camera 1.

The gyro sensor 100 detects shake in a yawing direction and shake (oscillation) in a pitching direction based on a change in an angle of the digital camera 1 per unit time, namely, an angular velocity. The gyro sensor 100 outputs a gyro signal (a) representing an amount of the detected shake (angular velocity) to a shake processor 310. The gyro signal includes a wide range of frequency components caused by camera shake, a mechanical noise or the like. Another sensor operable to detect shake of the digital camera 1 can be used instead of the gyro sensor 100.

The shake processor 310 executes various processes, described later, to the input gyro signal. The shake processor 310 as well as the controller 320 and the gyro sensor 100 composes the shake detecting apparatus 2a according to the first embodiment. The shake detecting apparatus 2a executes an arithmetic process, described later, based on the gyros signal from the gyro sensor 100, and outputs a lens control signal for correcting the optical axis by the camera shake correction lens 24. The shake detecting apparatus 2a as well as the camera shake correction lens 24 and the correction lens drive device 24a composes the shake correcting apparatus according to the first embodiment.

### 1-2. Configuration of Shake Detecting Apparatus

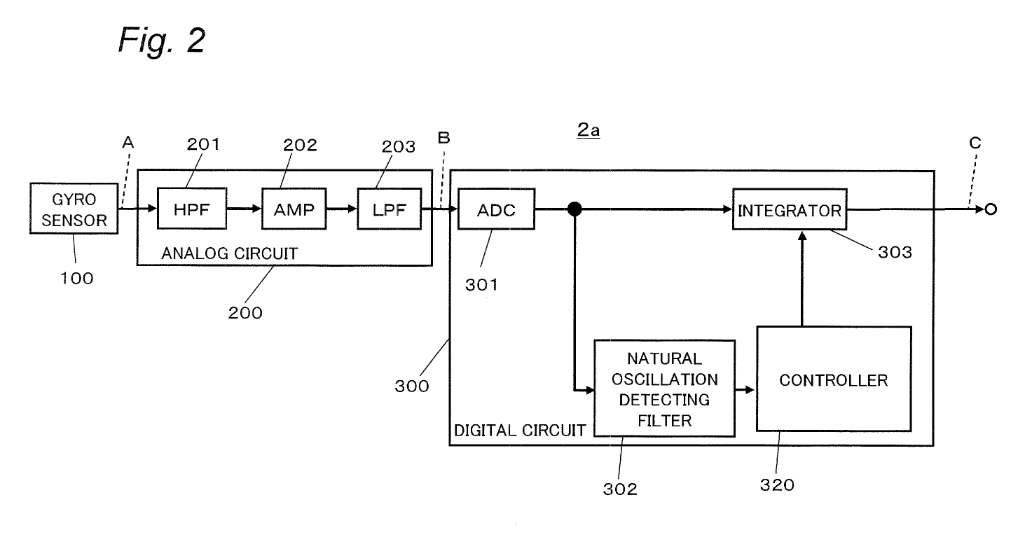

A detailed configuration of the shake detecting apparatus 2a according to the first embodiment is described with reference to FIG. 2. The shake detecting apparatus 2a according to the first embodiment includes the gyro sensor 100, an analog circuit section 200, and a digital circuit section 300. A combination of the analog circuit section 200 and a part of the digital circuit section 300 corresponds to the shake processor 310. The analog circuit section 200 includes a HPF (high pass filter) 201, an AMP (amplifier) 202, and an LPF (low pass filter) 203. The digital circuit section 300 includes an ADC (AD converter) 301, a natural oscillation detecting filter 302, an integrator 303, and the controller 320.

The gyro sensor 100 outputs the gyro signal A to the analog circuit section 200 which is a part of the shake processor 310 as described above. In the analog circuit section 200, an unnecessary DC component of the gyro signal is cut off by the HPF 201, and then the gyro signal is amplified by the AMP 202. Thereafter, its high-frequency component is cut off by the LPF 203.

The gyro signal A output from the gyro sensor 100 includes DC drift caused by a temperature change or a temporal change. For this reason, a low-frequency component of the gyro signal A is cut off by the HPF 201. If a gyro sensor having high DC accuracy is used, the HPF 201 can be omitted. Since an amplitude of the gyro signal A is smaller than resolution of the ADC 301 in the digital circuit section 300, the gyro signal A is amplified by the AMP 202. Since a frequency component of user's camera shake is in a range from 1 to 10 Hz, the LPF 203 cuts off the high-frequency component of the gyro signal A which is to be a noise. When a noise does not become a problem, the LPF 203 can be omitted.

The reason why the gyro signal A is input to the AMP 202 after the HPF 201 cuts off a low-frequency components caused by the DC drift of the gyro signal A is to prevent saturation of the output from the AMP 202. On the other hand, the LPF 203 may be inserted into any position.

The analog circuit section 200 executes various processes on the gyro signal A to output a gyro signal B to the digital circuit section 300. The gyro signal B output to the digital circuit section 300 is converted from an analog signal into a digital signal by the ADC 301. The gyro signal B as a converted digital signal is sent to both the integrator 303 and the natural oscillation detecting filter 302.

The integrator 303 integrates the gyro signal B as a signal representing the angular velocity of shake (oscillation) to convert it into a lens control signal C as a signal representing an angle of the shake (oscillation). On the other hand, the natural oscillation detecting filter 302 detects frequency components included in the gyro signal B in the frequency band of the natural oscillation of the gyro sensor 100. The controller 320 controls the integrator 303 according to the detection result in the natural oscillation detecting filter 302. Details of the control of the integrator by means of the oscillation detection are described later. The controller 320 controls the drive of the camera shake correction lens 24 based on the lens control signal C.

### 1-3. Control of Integrator by Detection of Natural Oscillation

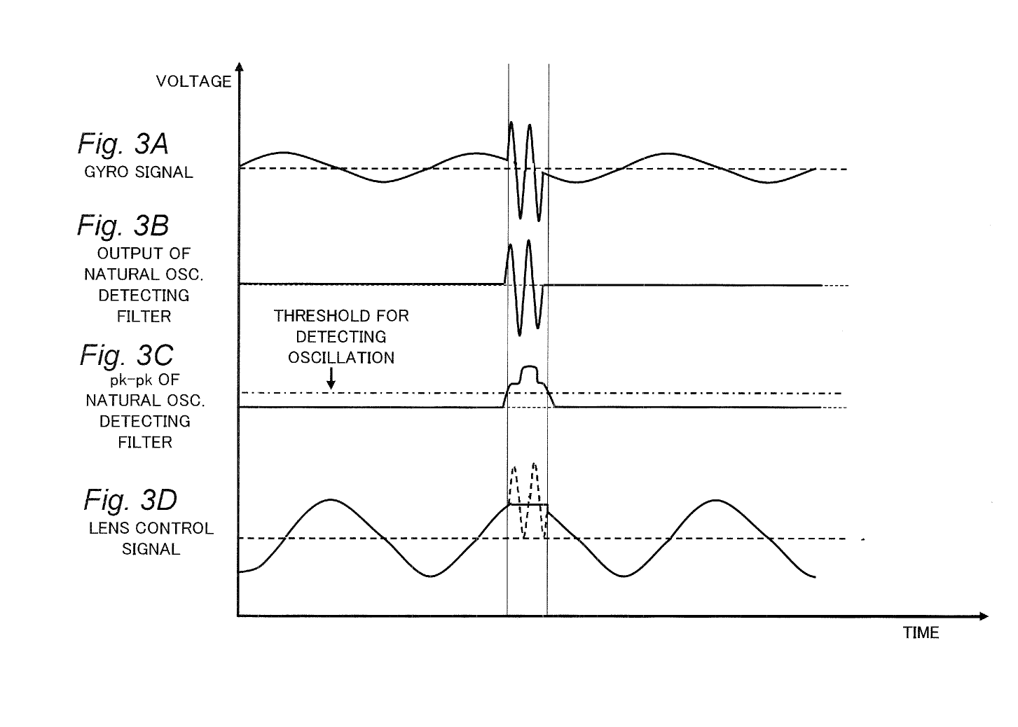

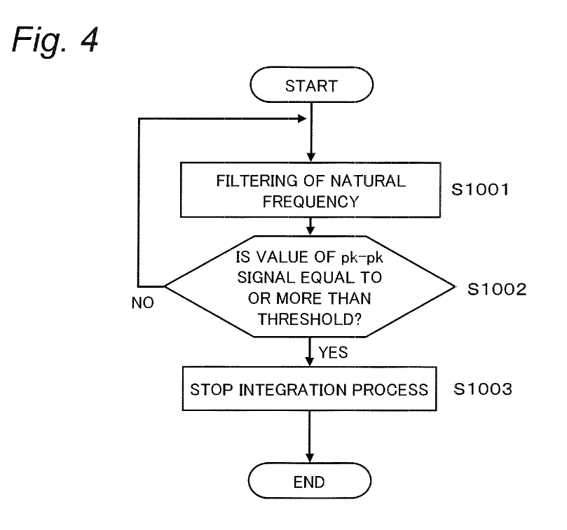

The details of the control of the integrator 303 in a case of detecting the oscillation (hereinafter, “natural oscillation”) having a natural frequency are described with reference to FIGS. 3A to 3D and 4. FIGS. 3A to 3D are diagrams describing signals to be processed by the shake detecting apparatus 2a according to the first embodiment. FIG. 4 is a flowchart illustrating an operation of the shake detecting apparatus 2a according to the first embodiment.

The gyro signal B (see FIG. 3A) is converted to a digital signal in the ADC 301 and then is transmitted to both the integrator 303 and the natural oscillation detecting filter 302. The natural oscillation detecting filter 302 filters a signal in a band including the natural frequency of the gyro sensor 100 from among the frequency components included in the sent gyro signal B (S1001) and outputs the filtered signal (see FIG. 3B). The signal output from the natural oscillation detecting filter 302 is transmitted to the controller 320.

The controller 320 generates a difference signal between a maximum peak and a minimum peak of the signal output from the natural oscillation detecting filter 302 (hereinafter, “pk-pk signal”) (see FIG. 3C). Thereafter, the controller 320 determines whether a value indicated by the pk-pk signal is a predetermined threshold or more (S1002). The threshold is set to be about 5 times as large as an output value generated by a normal electric noise, and so on. With such setting, it can be determined whether the filtered signal is a signal or a noise.

When the value indicated by the pk-pk signal is less than the threshold, the sequence returns to step S1001, and the controller 320 waits until natural oscillation is detected again. On the other hand, when the value indicated by the pk-pk signal is the threshold or more, the controller 320 controls the integrator 303 to stop the conversion from the gyro signal B as the angular velocity signal into the lens control signal C as the angle signal (S1003). While the conversion from the gyro signal B to the lens control signal C stops, the shake detecting apparatus 2a generates a lens control signal to hold the camera shake correction lens 24 at a position where the natural oscillation is detected (see FIG. 3D).

When the oscillation having the band of the natural frequency of the gyro sensor 100 is detected, the shake detecting apparatus 2a generates the lens control signal to hold the correction lens at the position where the oscillation is detected, so that the correction lens does not trace the detected oscillation. Thus, a malfunction of the correction lens can be prevented in the case of detecting the oscillation in the band of the natural frequency of the gyro sensor 100.

### 1-4. Conclusion

The shake correcting apparatus according to the first embodiment is a shake detecting apparatus for detecting shake of a detection target, and includes the camera shake correction lens 24 and the correction lens drive device 24a which correct the optical axis of the light from the subject according to the correction signal; the gyro sensor 100 which detects the shake of the digital camera 1 and outputs a detection signal according to the amount of the detected shake; the integrator 303 which generates the lens control signal based on the detection signal output from the gyro sensor 100; the natural oscillation detecting filter 302 which detects a frequency component of the detection signal in a predetermined frequency band, and the controller 320 which controls the integrator 303 to generate the lens control signal according to the detection result of the natural oscillation detecting filter 302. With this configuration, the shake correcting apparatus can change the lens control signal according to presence/non-presence of the detection of the natural oscillation, thereby preventing a malfunction based on the detection of the natural oscillation.

The predetermined frequency band is a band including the natural frequency at which the sensitivity of the gyro sensor 100 becomes remarkably high. In the shake correcting apparatus, the detecting apparatus 2a can control the generation of a lens control signal based on the detection of the oscillation having the natural frequency of the gyro sensor 100 causing a malfunction.

In the detecting apparatus 2a, when the shake amount represented by the detection signal is larger than a predetermined value, the controller 320 controls the integrator 303 so that the lens control signal according to the detection signal is not generated. Thus, the detecting apparatus 2a can prevent the oscillation having the natural frequency from being erroneously detected based on a noise.

### Second Embodiment

In a second embodiment, when the shake having the natural frequency of the gyro sensor 100 is detected, a correction amount for driving the camera shake correction lens 24 is reduced. A configuration and an operation of the shake detecting apparatus in the digital camera according to the second embodiment are described below. Since the configuration of the digital camera 1 shown in FIG. 1 is same as that in the second embodiment, the description thereof is omitted. The same or corresponding parts of the configuration between the first and second embodiments are denoted by the same signs. The configuration and the operation in the second embodiment same as those in the first embodiment are suitably omitted.

### 2-1. Configuration of Shake Detecting Apparatus

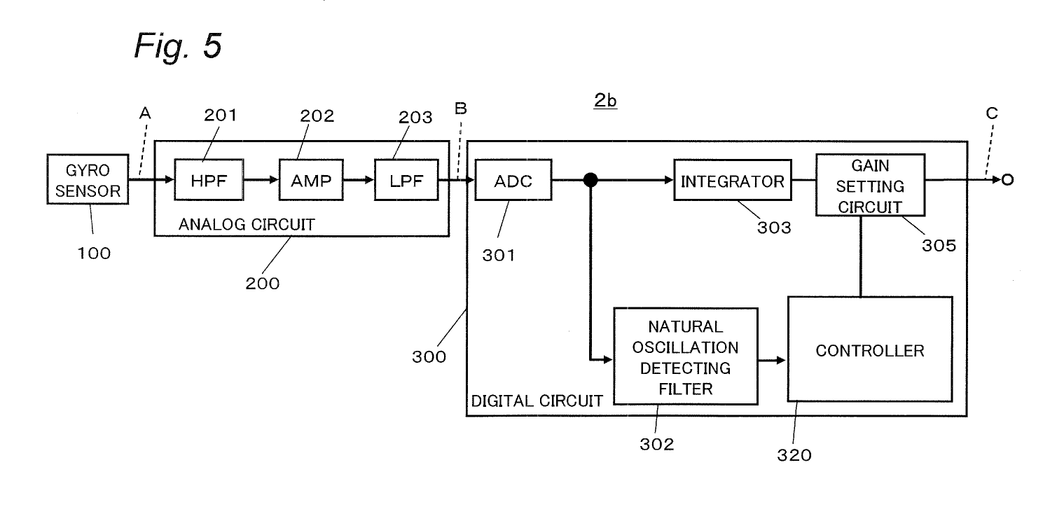

The configuration of the shake detecting apparatus according to the second embodiment is described with reference to FIG. 5. A shake detecting apparatus 2b in the second embodiment further includes a gain setting circuit 305 for changing a level of an input signal in the digital circuit section 300 in addition to the configuration of the shake detecting apparatus 2a according to the first embodiment. The controller 302 controls not the integrator 303 but the gain setting circuit 305. In this point the second embodiment is different from the first embodiment. Also in the second embodiment, the shake detecting apparatus 2b composes the shake correcting apparatus according to the second embodiment, as well as the camera shake correction lens 24 and the correction lens drive device 24a.

### 2-2. Gain Setting Control by Detection of Natural Oscillation

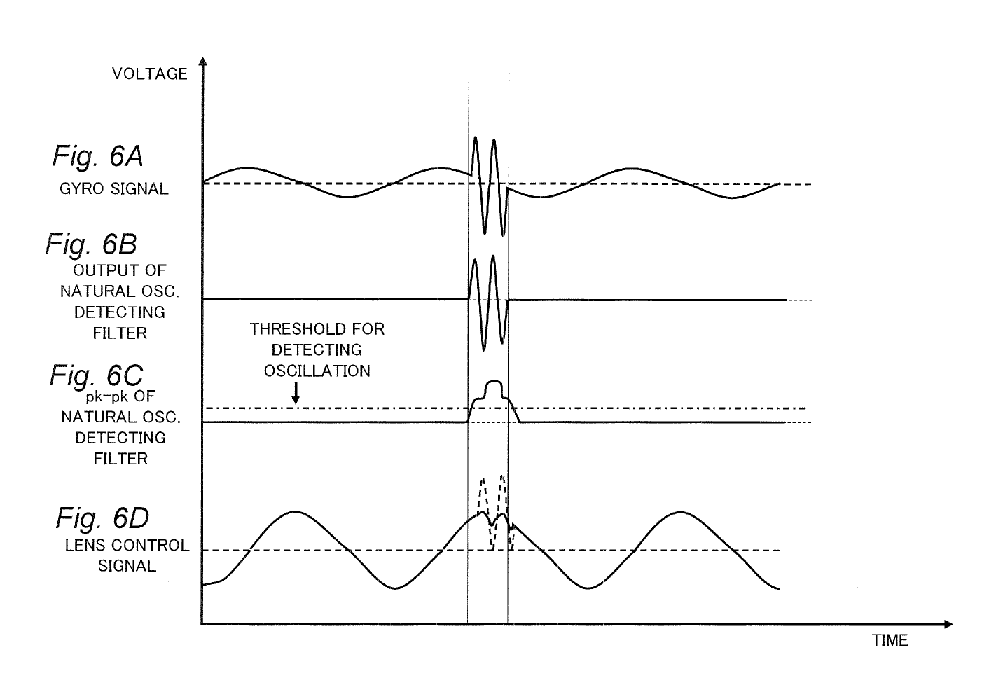

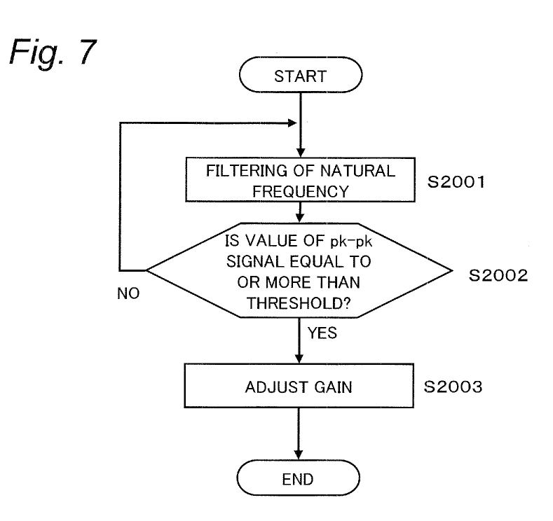

Details of the gain setting control by detection of natural oscillation are described with reference to FIGS. 6A to 6D and 7. FIGS. 6A to 6D are diagrams describing signals to be processed by the shake detecting apparatus 2b according to the second embodiment. FIG. 7 is a flowchart illustrating an operation of the shake detecting apparatus 2b according to the second embodiment.

The gyro signal B converted into a digital signal in the ADC 301 (see FIG. 6A) is transmitted to both the integrator 303 and the natural oscillation detecting filter 302. The natural oscillation detecting filter 302 filters a component including a natural frequency of the gyro sensor 100 from among frequency components included in the transmitted gyro signal B and outputs the filtered signal (S2001) (see FIG. 6B). The signal output from the natural oscillation detecting filter 302 is transmitted to the controller 320.

The controller 320 generates a pk-pk signal of the signal output from the natural oscillation detecting filter 302 (see FIG. 6C). Thereafter, the controller 320 determines whether a value indicated by the pk-pk signal is equal to or more than a threshold (S2002).

When the value indicated by the pk-pk signal is less than the threshold, the sequence returns to step S2001, so that the controller 320 waits until the natural oscillation is detected.

On the other hand, when the value indicated by the pk-pk signal is equal to or more than the threshold, the controller 320 controls the gain setting circuit 305 so that a level of a lens control signal output from the integrator 303 is reduced (S2003) (see FIG. 6D).

In this manner, only when the oscillation having the natural frequency of the gyro sensor 100 is detected, the shake detecting apparatus 2b according to the second embodiment controls the gain setting circuit 305 so that the level of the lens control signal (namely, the correcting amount) is reduced. With this configuration, a malfunction of the correction lens in the case of detecting the oscillation having the natural frequency can be prevented.

### 2-3. Conclusion

The shake correcting apparatus according to the second embodiment includes the camera shake correction lens 24 and the correction lens drive device 24a which correct the optical axis of the light from a subject according to the correction signal; the gyro sensor 100 which detects shake of the digital camera 1 and outputs the detection signal according to the amount of the detected shake; the integrator 303 and the gain setting circuit 305 which generate the lens control signal based on the detection signal output from the gyro sensor 100; the natural oscillation detecting filter 302 which detects the frequency component of the detection signal in the predetermined frequency band; and the controller 320 which controls the gain setting circuit 305 to generate the lens control signal according to a detection result in the natural oscillation detecting filter 302. Specifically, when the shake amount of the natural oscillation is larger than the predetermined value, the controller 320 controls the gain setting circuit 305 to reduce the level of the generated lens control signal.

With the above configuration, the shake correcting apparatus can change the lens control signal according to the presence/non-presence of the detection of the natural oscillation, and can prevent a malfunction based on the detection of the natural oscillation.

### Third Embodiment

The digital camera according to a third embodiment has the configuration similar to that of the digital camera 1 according to the first embodiment shown in FIGS. 1 and 2. The shake detecting apparatus 2a composing the shake correcting apparatus according to the third embodiment detects shake (oscillation) having the natural frequency of the gyro sensor 100 according to timing synchronizing with a drive synchronization signal generated when the shutter or various motors is/are driven. That is, in the case where the shake (oscillation) having the natural frequency of the gyro sensor 100 is detected, the shake detecting apparatus 2a does not perform calculation of the correction amount for driving the camera shake correction lens 24. An operation of the digital camera 1 according to the third embodiment is described below.

The drive synchronization signal is a signal generated when the shutter or various motors is/are driven. For example, it is a signal generated when pressing down a release button, or a signal generated when the motor for driving the zoom lens or the focus lens is driven. The timing the mechanical noise which is one cause of the shake of the digital camera 1 occurs is a timing a movable member such as the shutter or the motor is driven. Therefore, By performing the control according to the timing such a mechanical noise possibly occurs, namely, the timing synchronizing with the drive synchronization signal, the detecting apparatus 2c can efficiently generate the lens control signal.

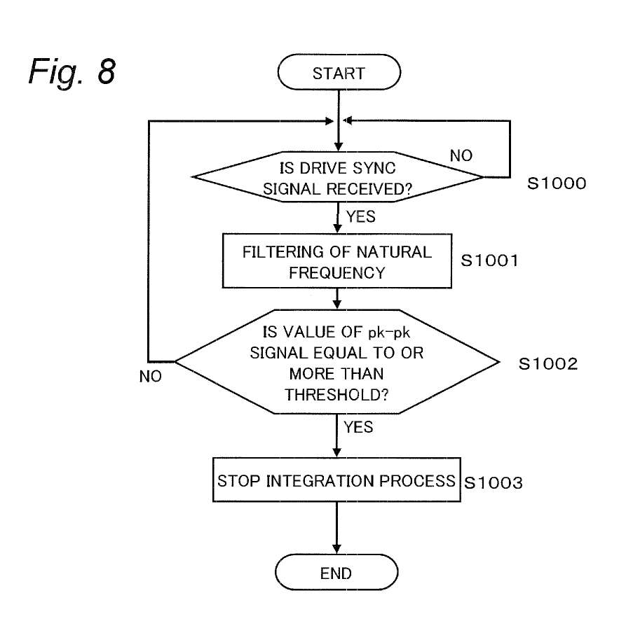

FIG. 8 is a flowchart describing the operation of the detecting apparatus 2a according to the third embodiment. In FIG. 8, processes same as those of the detecting apparatus 2a in the first embodiment are denoted by the same signs.

The controller 320 monitors presence/non-presence of the drive synchronization signal generated when driving the shutter or the various motors (S1000). When the controller 320 detects the generation of the drive synchronization signal (YES in S1000), it sequentially executes processes in steps S1001 to S1003. Since the processes in steps S1001 to S1003 are similar to those in the first embodiment, the description thereof is omitted.

As described above, the third embodiment has the configuration including the TG 17 and the controller 320 that generate the drive synchronization signal for driving the respective sections of the digital camera 1 having the detecting apparatus 2a. The controller 320 performs a control according to the timing synchronizing with the drive synchronization signal. Thus, the detecting apparatus 2a according to the third embodiment can output the lens control signal according to the timing synchronizing with the drive synchronization signal.

### Fourth Embodiment

The digital camera according to a fourth embodiment has the configuration similar to that of the digital camera 1 according to the second embodiment shown in FIGS. 1 and 5. The shake detecting apparatus 2b composing the shake correcting apparatus according to the fourth embodiment detects shake (oscillation) having the natural frequency of the gyro sensor 100 according to the timing synchronizing with the drive synchronization signal generated when the shutter or the various motors is/are driven. When the shake detecting apparatus 2b detects shake (oscillation) having the natural frequency of the gyro sensor 100, the gain of a correction amount for driving the camera shake correction lens 24 is reduced. An operation of the digital camera 1 according to the fourth embodiment is described below.

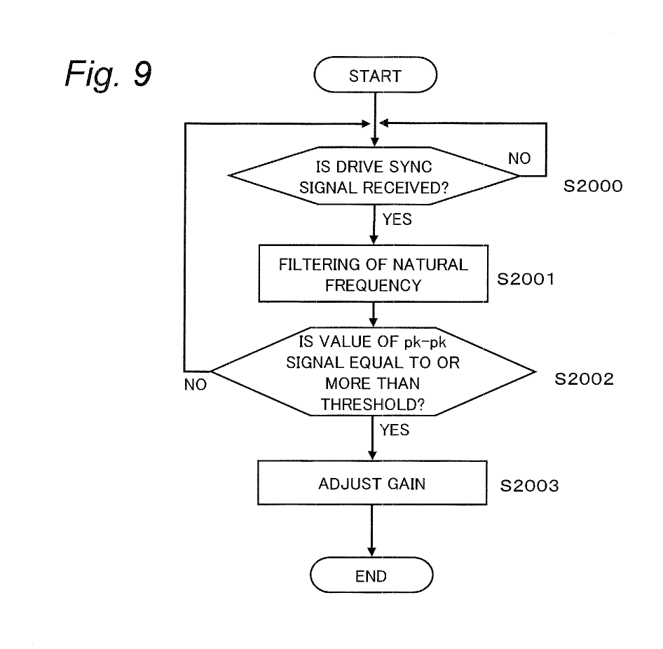

FIG. 9 is a flowchart describing an operation of the detecting apparatus 2b according to the fourth embodiment. In FIG. 9, processes common with those of the detecting apparatus 2b according to the second embodiment are denoted by the same signs.

The controller 320 monitors presence/non-presence of the drive synchronization signal generated when driving the shutter and the various motors (S2000). If the controller 320 detects the generation of the drive synchronization signal (YES in S2000), it sequentially executes the processes in steps S2001 to S2003. Since the processes in steps S2001 to S2003 are similar to those in the second embodiment, the description thereof is omitted.

As described above, the fourth embodiment has the configuration including the TG 17 and the controller 320 that generate the drive synchronization signals for driving the respective sections of the digital camera 1 having the detecting apparatus 2b. The controller 320 performs control according to the timing synchronizing with the drive synchronization signal. Thus, the detecting apparatus 2b according to the fourth embodiment can output the lens control signal according to the timing synchronizing with the drive synchronization signal. With this configuration, the control can be performed according to the timing a mechanical noise as cause of the shake of the digital camera 1 possibly occurs, so that the lens control signal can be efficiently generated.

### Other Embodiment

In the above embodiments, the natural oscillation detecting filter 302 detects the frequency band including the natural frequency of the gyro sensor 100. It is enough that the frequency band detected by the natural oscillation detecting filter 302 includes the natural frequency of the gyro sensor 100, and the band width can be suitably set. For example, when the natural frequency of the gyro sensor 100 is 750 Hz, the natural oscillation detecting filter 302 may detect a band width of 500 to 1000 Hz.

The above embodiments describe the case where the oscillation having the natural frequency of the gyro sensor 100 is detected, but the embodiment is not limited to this. That is, when oscillation having a predetermined frequency is detected, the above control may be performed.

In the first embodiment, while the conversion from the gyro signal B into the lens control signal C stops, the shake detecting apparatus 2a does not generate the signal for correcting the camera shake correction lens 24. Instead of this control, the shake detecting apparatus may output a lens control signal generated by linearly interpolating a signal amount between the time the conversion from the gyro signal B to the lens control signal C stops and the time the conversion restarts.

In the second embodiment, the shake detecting apparatus 2b converts the gyro signal B into the lens control signal C, and then reduces the gain of the lens control signal. However, the embodiment is not limited to this. For example, the gain setting circuit 305 may be inserted into a front stage of the integrator 303. That is, after reducing the gain of the gyro signal B in the band where the natural oscillation is detected, the integrator 303 may convert the gyro signal B into the lens control signal C.

The above embodiments describe the case where the correction lens 24 is corrected based on the lens control signal generated by the detecting apparatus. However, the embodiment is not limited to this. That is, the camera shake may be corrected not only by shifting the correction lens 24 but also by shifting the CCD image sensor. In this case, the shake detecting apparatus according to the present invention generates a signal for correcting the optical axis by shifting the CCD image sensor 14. Even in the camera shake correcting method by shifting the CCD image sensor 14, the method for generating a correction signal is same as the case of the camera shake correcting method by shifting the correction lens 24. In this case, the CCD image sensor 14 is one example of the correcting unit.

According to the first and second embodiments, in the shake detecting apparatus 2a, the integrator 303 integrates the gyro signal B representing the angular velocity to generate a lens control signal including information representing the angle. However, the embodiment is not limited to this configuration, the integrator 303 may not be provided, and the gyro signal B representing the angular velocity may be output as the lens control signal.

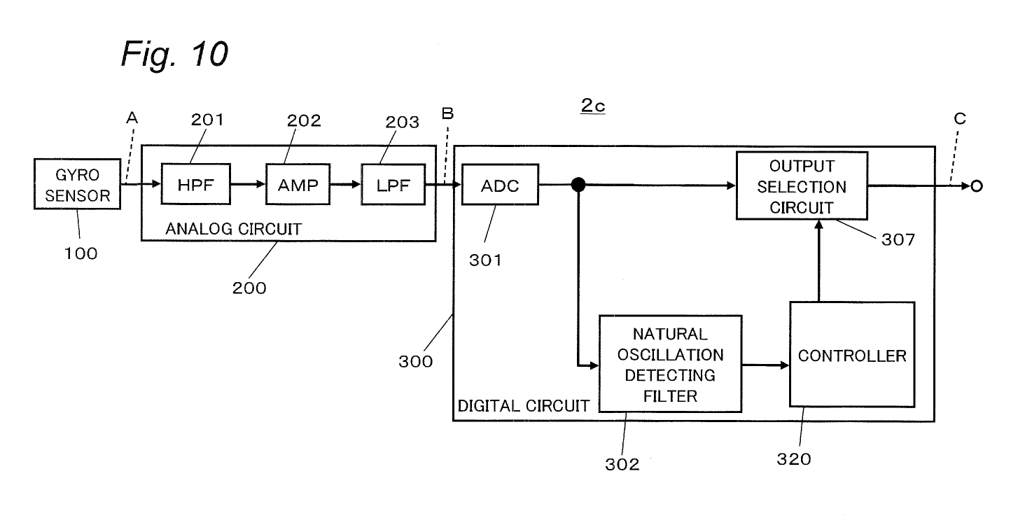

Specifically, in the configuration according to the first embodiment (see FIG. 2), as shown in FIG. 10, a output selection circuit 307 controlled by the controller 320 may be provided instead of the integrator 303. In this case, when the value indicated by the pk-pk signal is equal to or more than the threshold, the controller 320 controls the output selection circuit 307 to hold the gyro signal B at detection of the natural oscillation to be 0 and to output the held gyro signal. That is, while the value indicated by the pk-pk signal is equal to or more than the threshold, the shake detecting apparatus 2a generates a lens control signal to hold the camera shake correction lens 24 at the position when the natural oscillation is detected. On the other hand, when the value indicated by the pk-pk signal is less than the threshold, the controller 320 controls the output selection circuit 307 to directly output the gyro signal B input to the shake detecting apparatus 2a.

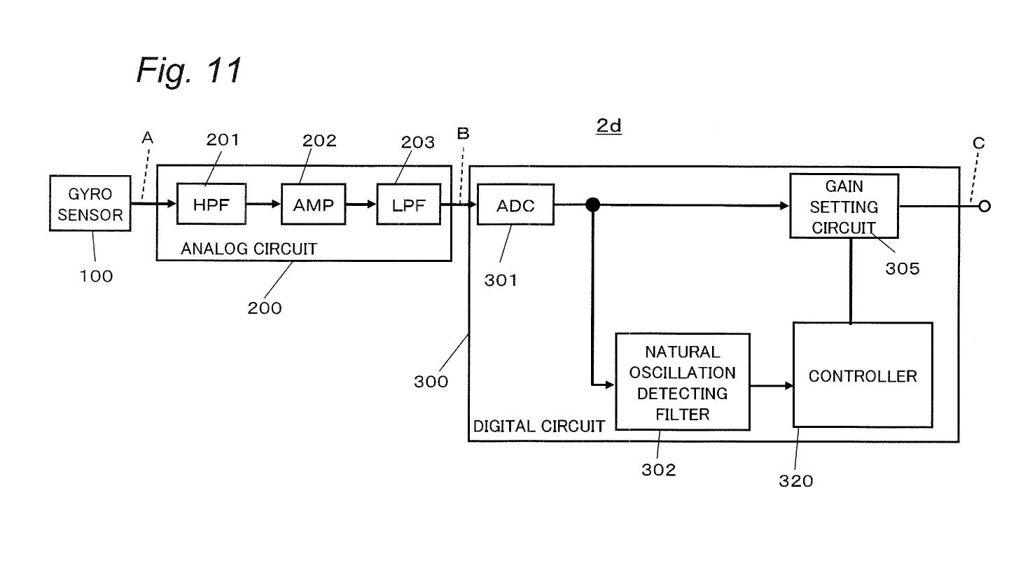

In the configuration according to the second embodiment (see FIG. 5), as shown in FIG. 11, the integrator 303 may be eliminated. In this case, the operation of the controller 320 for the gain setting circuit 305 is similar to that described in the second embodiment.

Similarly, also in the third and fourth embodiments, the gyro signal B representing the angular velocity may be output as the lens control signal.

### INDUSTRIAL APPLICABILITY

The embodiment can be applied to an electronic apparatus provided with a camera shake detecting apparatus, such as an imaging apparatus like a digital camera, a camcorder, and a cellular phone.

What is claimed is:

1. A shake correcting apparatus for correcting shake of an optical axis, comprising:
a correcting unit operable to correct the optical axis of light from a subject according to a correction signal;
a shake detecting unit operable to detect the shake of the apparatus to output a detection signal according to an amount of the detected shake;
a correction signal generating unit operable to generate the correction signal based on the detection signal output from the shake detecting unit;
a natural oscillation detecting unit operable to detect a frequency component of the detection signal in a predetermined frequency band; and
a controller operable to control the correction signal generating unit to generate the correction signal according to a detection result of the natural oscillation detecting unit.

2. The shake correcting apparatus according to claim 1, wherein the predetermined frequency band is a band including a natural frequency at which a sensitivity of the shake detecting unit is remarkably high.

3. The shake correcting apparatus according to claim 1, wherein when a value represented by the detection result is higher than a predetermined value, the controller controls the correction signal generating unit so that the correction signal is not generated based on the detection signal.

4. The shake correcting apparatus according to claim 1, wherein, when a value represented by the detection result is higher than a predetermined value, the controller controls the correction signal generating unit so that a gain for generating the correction signal by the correction signal generating unit is less than that when the value represented by the detection result is lower than the predetermined value.

5. The shake correcting apparatus according to claim 1, further comprising:
a synchronization signal acquiring unit operable to acquire a synchronization signal generated when driving a movable member included in a target of which shake is detected,
wherein when the synchronization signal is acquired, the controller controls the correction signal generating unit to generate the correction signal according to the detection result of the natural oscillation detecting unit.

6. An imaging apparatus having an optical system and an imaging unit operable to capture a subject image input via the optical system, comprising:
a correcting unit operable to correct an optical axis of light from a subject according to a correction signal;
a shake detecting unit operable to detect shake of the imaging apparatus and output a detection signal according to an amount of the detected shake;
a correction signal generating unit operable to generate the correction signal based on the detection signal output from the shake detecting unit;
an natural oscillation detecting unit operable to detect a frequency component of the detection signal in a predetermined frequency band; and
a controller operable to control the correction signal generating unit to generate the correction signal according to a detection result of the natural oscillation detecting unit.

7. The imaging apparatus according to claim 6, wherein the predetermined frequency band is a band including a natural frequency at which a sensitivity of the shake detecting unit is remarkably high.

8. The imaging apparatus according to claim 6, wherein when a value represented by the detection result is higher than a predetermined value, the controller controls the correction signal generating unit so that the correction signal is not generated based on the detection signal.

9. The imaging apparatus according to claim 6, wherein, when a value represented by the detection result is higher than a predetermined value, the controller controls the correction signal generating unit so that a gain for generating the correction signal by the correction signal generating unit is less than that when a value represented by the detection result is lower than the predetermined value.

10. The imaging apparatus according to claim 6, further comprising:
a synchronizing signal generating unit operable to generate a synchronization signal generated when driving a movable member included in the imaging apparatus,
wherein when the synchronization signal is generated, the controller controls the correction signal generating unit to generate the correction signal according to the detection result of the oscillation detecting unit.
